(19) United States
(12) Patent Application Publication
(10) Pub. No.: US 2008/0059497 A1
(43) Pub. Date: Mar. 6, 2008

(54) DATA STORING DEVICE, RECORDING MEDIUM, COMPUTER DATA SIGNAL, AND CONTROL METHOD FOR DATA STORING

(75) Inventors: Mitsuhiro ISHIBE, Kawasaki-shi (JP); Sunao Hashimoto, Kawasaki-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Minato-ku (JP)

(21) Appl. No.: 11/738,544

(22) Filed: Apr. 23, 2007

(30) Foreign Application Priority Data
Aug. 29, 2006 (JP) 2006-232064

(51) Int. Cl. G06F 17/30

(52) U.S. Cl. 707/100

(57) ABSTRACT

Provided is a data storing device which stores plural data items and management information related to storing of each data item in an associated manner, detects, from the plural stored data items, plural data items of which at least a part of contents are common to each other, selects a data item to be stored continuously from the detected data items, and associates management information of a data item which is not selected from the detected data items with the selected data item as management information of the selected data item.

### CROSS-REFERENCE TO RELATED APPLICATIONS

This application is based on and claims priority under 35 USC 119 from Japanese Patent Application No. 2006-232064 filed on Aug. 29, 2006.

### BACKGROUND

1. Technical Field

The invention relates to a data storing device, a recording medium, a computer data signal, and a control method for data storing.

2. Related Art

There are data storing devices for storing various types of data, such as document servers for managing document data. In those data storing devices, multiple items of data having the same contents maybe registered. In this case, a larger storage capacity of a hard disk or the like is required to store those items of data having the same contents, which leads to lower storage efficiency.

### SUMMARY

According to an aspect of the invention, there is provided a data storing device, including: a storage that stores plural data items and management information related to storing of each data item in an associated manner; a detecting section that detects, from the plural stored data items, plural data items of which at least a part of contents are common to each other; a selecting section that selects a data item to be stored continuously from the detected data items; and a management information updating section that associates management information of a data item which is not selected from the detected data items by the selecting section, with the selected data item as management information of the selected data item.

### BRIEF DESCRIPTION OF THE DRAWINGS

An exemplary embodiment of the present invention will be described in detail based on the following figures, wherein:

FIG. 1 is a block diagram schematically showing the configuration of a data storing device according to an exemplary embodiment of the invention;

FIG. 2 is a functional block diagram showing functions of the data storing device according to the exemplary embodiment of the invention;

FIG. 3 is an exemplary diagram conceptually explaining multiple data items stored by the data storing device according to the exemplary embodiment of the invention;

FIG. 4 is an exemplary diagram conceptually explaining multiple data items obtained after processing is executed with respect to common data in the data storing device according to the exemplary embodiment of the invention;

FIG. 5 is a flowchart showing an example of the processing executed by the data storing device according to the exemplary embodiment of the invention; and

FIG. 6 is a flowchart showing an example of data restoration processing executed by the data storing device according to the exemplary embodiment of the invention.

### DETAILED DESCRIPTION

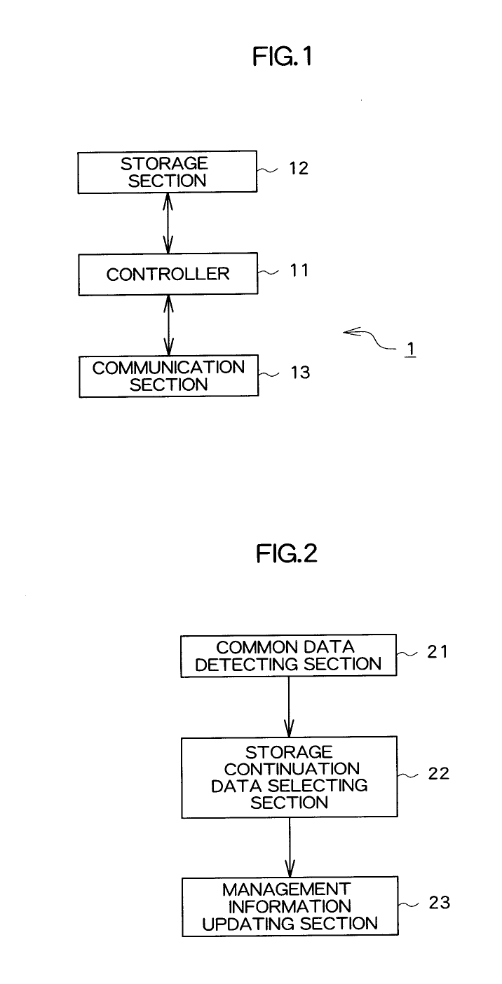

Hereinafter, an exemplary embodiment of the invention will be described with reference to the figures. As shown in FIG. 1, a data storing device 1 according to the exemplary embodiment of the invention includes a controller 11, a storage section 12, and a communication section 13.

The controller 11 is a CPU or the like and operates according to a program stored in the storage section 12. In this exemplary embodiment, the controller 11 detects data that include common contents from data stored in the storage section 12 and executes processing with respect to the detected data. An example of the processing executed by the controller 11 in this exemplary embodiment will be described later.

The storage section 12 includes at least one of a memory device such as a RAM or a ROM and a disk device such as a hard disk drive. The storage section 12 stores the program executed by the controller 11 in this exemplary embodiment. Further, the storage section 12 operates as a work memory for the controller 11.

Further, in this exemplary embodiment, the storage section 12 stores data to be stored by the data storing device 1. The data may be any types of data that can be recorded in a computer, such as text data, drawing data, and image data. The data maybe document data to be managed in a document management system, for example.

The storage section 12 also holds management information related to storing of each data, in association with the data. For example, the management information includes information regarding data registration, such as a user who has registered data in the data storing device 1 and its registration date and time, and access history information indicating a user who has accessed data after the data is stored in the data storing device 1, its access date and time, and an access content (access type such as referring to, printing, or updating the data). The management information may further include various types of attribute information of data, such as classification information of data or associated keywords. When there are restrictions on users who may have access to the data, access right setting information regarding the access restrictions may be included in the management information.

The data may be classified into hierarchical folders and stored. In this case, the storage section 12 holds folder information on each of the folders. The folder information includes ID information of data classified into each folder, data location information (for example, a memory address of the storage section 12), and a folder ID of a subordinate folder of the folder in question. Note that when the data is classified into folders as in this case, the management information associated with the data may include link information indicating a folder from which the data is referred to or a folder from which the data was referred to in the past.

The communication section 13 is a network interface such as a LAN board, and transmits various types of data to a communication network under the control of the controller 11. The communication section 13 also receives data reached via the communication network and outputs the data to the controller 11.

Hereinafter, a description is given of functions realized by the data storing device 1 in this exemplary embodiment. As shown in FIG. 2, the data storing device 1 functionally includes a common data detecting section 21, a storage continuation data selecting section 22, and a management information updating section 23. Those functions may be realized when the controller 11 executes the program stored in the storage section 12. The program may be provided via the communication network such as the Internet, or may be provided by being stored in various types of computer-readable information recording media, such as a CD-ROM and a DVD-ROM.

The common data detecting section 21 detects multiple data items (hereinafter, referred to as common data) of which at least part of contents are common to each other, from multiple items of stored data. Hereinafter, a group of detected common data, which includes a common content, is referred to as a common data group.

Specifically, the common data detecting section 21 compares the contents of respective data items stored in the storage section 12 to detect common data. In this case, the common data may be data items whose contents are entirely common to each other or partially common to each other within a range of a predetermined condition. For example, the common data may be data items having common data contents other than title information, indicating the title of the document, which differ from each other.

Even if data items have data contents at least part of which are common to each other, when a predetermined condition is satisfied, the data items may not be selected as common data. For example, data items that belong to the same folder may be excluded from objects to be detected as common data. In addition, data that have predetermined attribute information (for example, an attribute of deletion disabled) may be excluded from objects to be detected as common data.

The storage continuation data selecting section 22 selects storage continuation data, that is, data to be continuously stored, from the common data included in the common data group, detected by the common data detecting section 21. For example, the storage continuation data selecting section 22 selects storage continuation data based on the management information associated with each item of the common data. Specific examples of the selection of storage continuation data include a case where data whose registration date and time or last update date and time are latest is selected, and a case where data which is most frequently accessed is selected. The storage continuation data selecting section 22 may select storage continuation data based on a designation by a user having an administrative right. In general, one data item is selected as storage continuation data. However, multiple data items may be selected depending on a condition such as the content of user designation.

The management information updating section 23 associates, among the common data included in the detected common data group, the management information of a data item which is not selected as storage continuation data by the storage continuation data selecting section 22, with the storage continuation data item which is selected by the storage continuation data selecting section 22 as its management information.

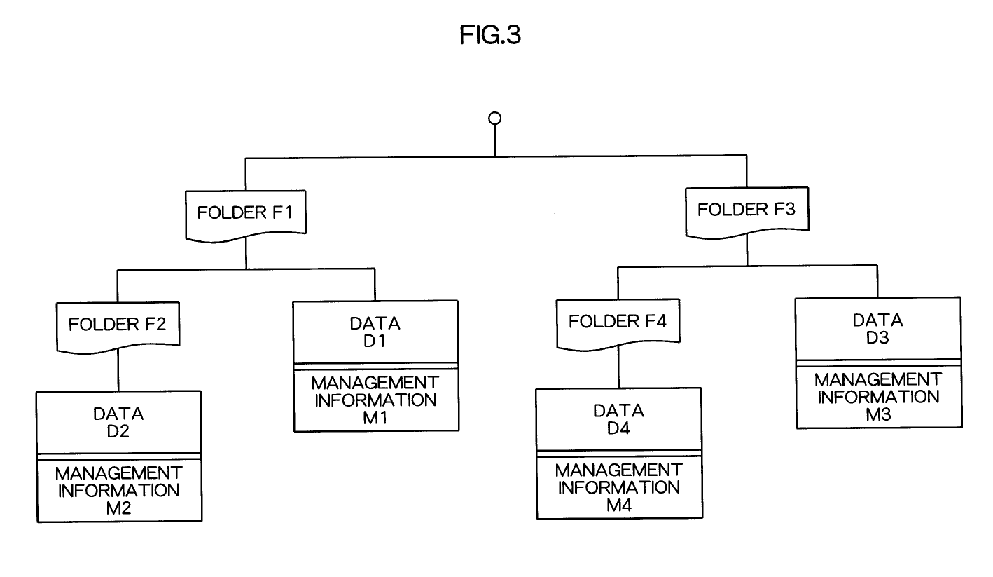

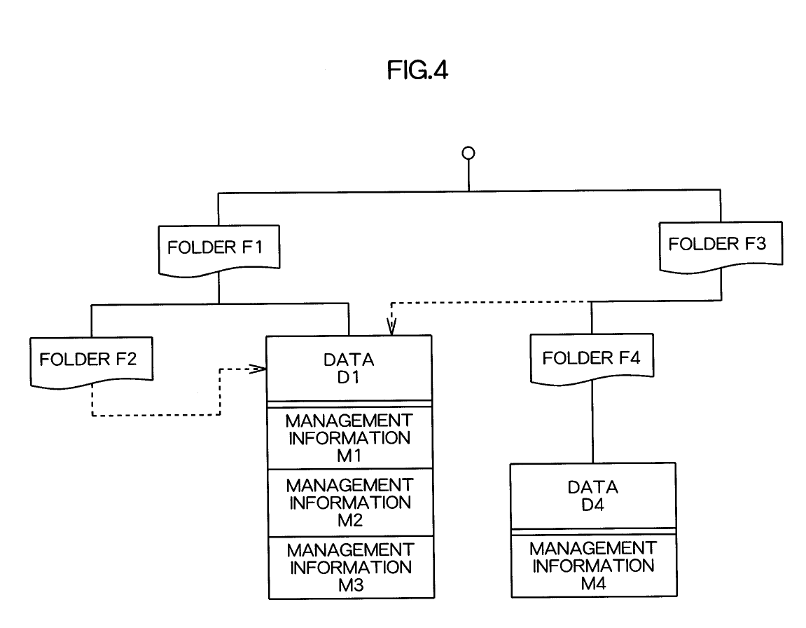

A description is given of a specific example case where data items stored by the data storing device 1 are classified into respective folders as conceptually shown in FIG. 3. In the example of FIG. 3, a folder F1 includes a subordinate folder F2 and data D1, and a folder F3 includes a subordinate folder F4 and data D3. Further, the subordinate folder F2 includes data D2, and the subordinate folder F4 includes data D4. Furthermore, management information M1, M2, M3, and M4 are associated with data D1, D2, D3, and D4, respectively.

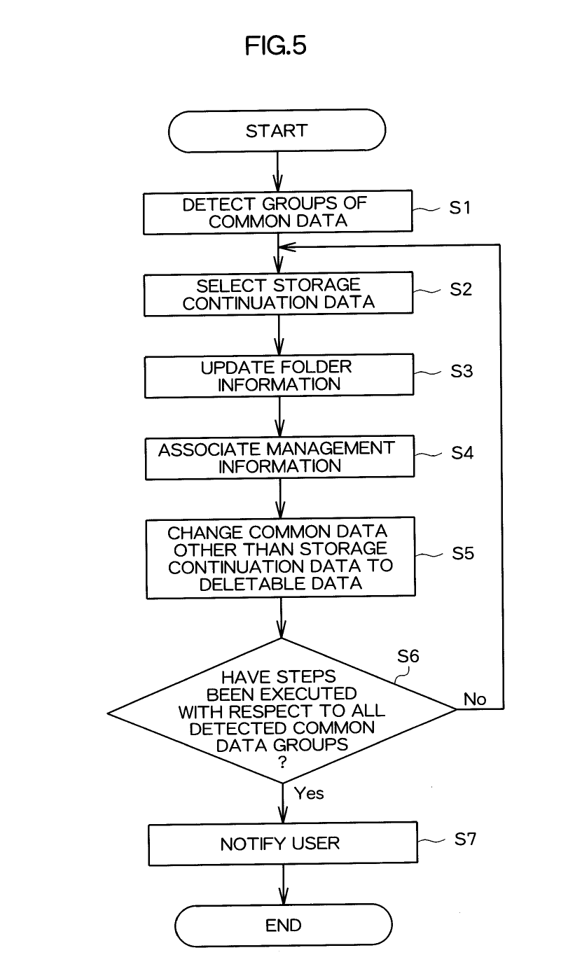

In this example, it is assumed that the common data detecting section 21 detects three data items, i.e., the data D1, D2, and D3, as common data, and the storage continuation data selecting section 22 selects, from those data items, the data D1 as storage continuation data. In this case, the management information updating section 23 associates the management information M2 and M3, associated with the data D2 and D3, respectively, as management information of storage continuation data D1. As a result, the management information of the storage continuation data D1 is updated to include the management information M1, M2, and M3, as shown in FIG. 4.

The management information updating section 23 also performs processing of arranging data which is not selected as the storage continuation data by the storage continuation data selecting section 22, among the common data included in the detected common data group. Specifically, in this processing, for example, the common data other than the storage continuation data is deleted from the storage section 12. FIG. 4 shows an example case where the data items D2 and D3, which are common data and are not selected as storage continuation data, are deleted.

Alternatively, the management information updating section 23 does not immediately delete the common data other than the storage continuation data, but may change it to deletable data. Specifically, in this processing, the common data other than the storage continuation data is moved to a predetermined folder such as a temporary save folder. In this case, each data item moved to the temporary save folder may be held in the temporary save folder in association with its original folder information. When it becomes necessary later to restore data which has been saved in the temporary save folder, a location to which the data should be restored is identified based on the original folder information associated with the data.

Alternatively, the management information updating section 23 may add attribute information indicating that data is deletable to the management information of the common data other than the storage continuation data. Those data items changed to deletable data may be deleted when a user such as an administrator expressly instructs later to do so, or may be deleted automatically after an elapse of a predetermined period of time.

When data are classified into folders and managed, the management information updating section 23 may update folder information. Specifically, the management information updating section 23 updates the folder information of a folder to which data (common data other than storage continuation data) to be deleted or moved to the temporary save folder belongs, to change the location information of the data other than storage continuation data to the location information of the storage continuation data. When the data storing device 1 deletes data that have duplicated contents, a user who used to access the deleted data via a particular folder accesses storage continuation data having the same contents as the deleted data based on the location information of the storage continuation data, included in the folder information of the particular folder. The dashed-line arrows of FIG. 4 indicate that the storage continuation data can be referred to via folders to which deleted data belonged, after the updating of the folder information described above.

A description is given of a specific example of new management information of the data D1, obtained when the management information updating section 23 adds the management information M2 and M3 to the management information of the data D1, in the above-mentioned example.

For example, the management information updating section 23 may update the management information of the storage continuation data D1 such that each of the management information M1, M2, and M3 serves as management information of the data D1 independently. In this case, the management information updating section 23 associates the management information of the data and information identifying the data, with the data D1 as its management information. For example, the management information M2 and M3 and the data IDs of the data D2 and D3 are added to the management information of the data D1.

In this example, when the user wants to refer to the management information of deleted data later, the data storing device 1 provides the user with the management information associated with information identifying the deleted data, which is specified by the user. In the above-mentioned example, in order to refer to the management information of the data D2 or D3 after it has been deleted, the user such as the administrator, by specifying information on the deleted data D2 or D3, refers to the contents of the management information M2 or M3 that was associated with the data D2 or D3 before the data D2 or D3 has been deleted, from among items of management information associated with the data D1.

Alternatively, the management information updating section 23 may perform merge processing of combining the management information M2 and M3 and the management information M1, which has been associated with the data D1, to generate a new single item of management information, and associate the merged management information with the data D1. In this case, for example, when items of attribute information included in the multiple items of management information contradict each other, attribute information to be associated with the data D1 may be determined by giving priority to the value of attribute information included in more items of management information. Alternatively, the value of attribute information included in the management information M1, which has been originally associated with the data D1, may be maintained.

When access right information included in the management information of the common data contradict each other, new access right information may be determined for the data D1 using an OR condition, so as to avoid a situation where the user who had the right to access any of the common data cannot access it any more. Alternatively, new access right information of the data D1 may be determined using an AND condition with security being emphasized. A rule to merge items of management information may be determined based on a designation by the user.

Next, a description is given of an example flow of processing performed by the data storing device 1 with reference to a flowchart of FIG. 5. For example, the processing may be performed at a predetermined point in time, such as at night while data is accessed relatively less often.

First, the common data detecting section 21 detects groups of common data (S1) . Steps S2 to S5 are performed for each group of common data detected in Step S1.

The storage continuation data selecting section 22 selects storage continuation data from a processing-target common data group (S2). The management information updating section 23 updates the folder information of a folder to which the common data other than the storage continuation data belongs (S3). Specifically, the management information updating section 23 changes the data storage location information of the common data, included in the folder information to the data storage location information of the storage continuation data selected in Step S2.

Further, the management information updating section 23 associates the management information associated with each item of the common data other than the storage continuation data, with the storage continuation data as its management information (S4). The management information updating section 23 changes each item of the common data other than the storage continuation data to deletable data (S5). In this case, specifically, the management information updating section 23 moves the common data other than the storage continuation data to the temporary save folder.

Next, the data storing device 1 judges whether Steps S2 to S5 have been performed for all the common data groups detected in Step S1 (S6). When Steps S2 to S5 have not been performed for all the common data groups, the processing returns to Step S2 to continue the steps for the next common data group.

On the other hand, when it is judged in Step S6 that Steps S2 to S5 have been performed for all the common data groups, the data storing device 1 notifies the user of information on data which has been changed to deletable data (S7). Specifically, the notification is performed, for example, by sending email that includes the information on data which has been changed to deletable data, to the user such as the administrator. The notification may be performed to the user who has registered each data item.

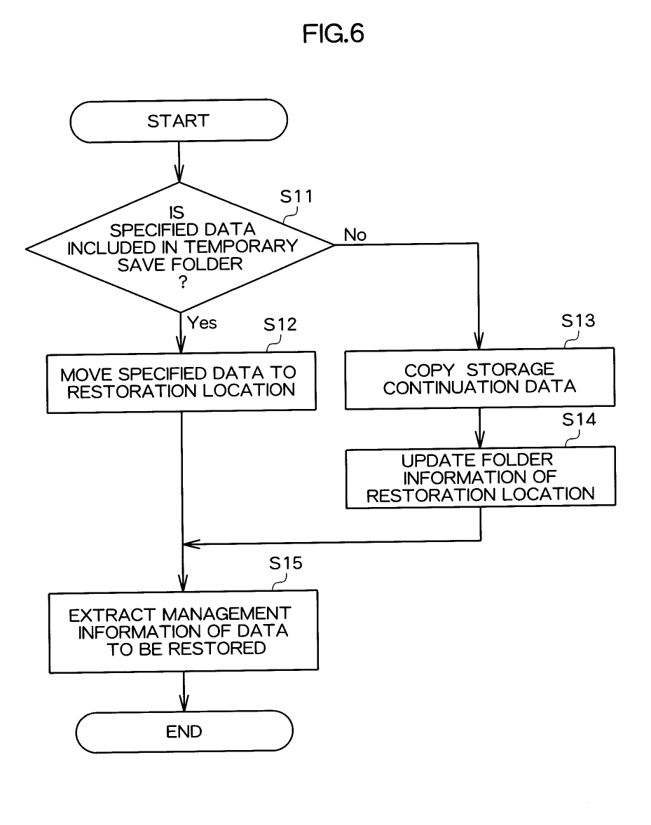

Next, with reference to a flowchart of FIG. 6, a description is given of an example flow of data restoration processing performed by the data storing device 1 when the common data other than the storage continuation data needs to be restored, after the processing of arranging duplicated data, shown in the flowchart of FIG. 5, is performed. When data which has duplicated contents but needs to be stored in a separate folder and managed because it has a different attribute is deleted through the above-mentioned processing, the data restoration processing is performed to restore the deleted data to an original state according to a designation by the user.

First, the data storing device 1 judges whether data specified by the user as a restoration target is included in the temporary save folder (S11) . When the data to be restored is included in the temporary save folder, the data storing device 1 moves the data included in the temporary save folder to a location where the data is to be restored (S12) . Specifically, the data storing device 1 adds the data storage location information of the data included in the temporary save folder to the folder information of a folder to which the data to be restored belonged.

On the other hand, when the data to be restored has already been deleted from the temporary save folder, the data storing device 1 copies storage continuation data having the same contents as the data to be restored and stores the copy as the data to be restored in the storage section 12 (S13). The data storing device 1 adds the data storage location information of the data to be restored which is stored in Step S13 to the folder information of the folder to which the data to be restored belonged (S14).

After Step S12 or S14 is performed, the data storing device 1 extracts, from the management information associated with the storage continuation data, the management information associated with the data to be restored and associates the extracted management information with the restored data (S15). Note that Step S15 is realized by referring to the management information associated with the ID information of the data to be restored, from the management information of the storage continuation data. Through the above-mentioned processing, the data to be restored is restored together with the folder to which it belonged and the management information.

The foregoing description of the exemplary embodiments of the invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A data storing device, comprising:
a storage that stores a plurality of data items and management information related to storing of each data item in an associated manner;
a detecting section that detects, from the plurality of stored data items, a plurality of data items of which at least a part of contents are common to each other;
a selecting section that selects a data item to be stored continuously from the detected data items; and
a management information updating section that associates management information of a data item which is not selected from the detected data items by the selecting section, with the selected data item as management information of the selected data item.

2. A computer readable recording medium storing a program causing a computer connected to a storage that stores a plurality of data items and management information related to storing of each data item in an associated manner to perform a function comprising:
detecting, from the plurality of stored data items, a plurality of data items of which at least a part of contents are common to each other;
selecting a data item to be stored continuously from the detected data items; and
associating management information of a data item which is not selected from the detected data items with the selected data item as management information of the selected data item.

3. The recording medium according to claim 2, the function further comprising:
merging management information of the data item which is not selected from the detected data items and management information which has already been associated with the selected data item; and
associating merged information with the selected data item as new management information.

4. The recording medium according to claim 2, the function further comprising:
associating management information of the data item which is not selected from the detected data items and information identifying the data item, with the selected data item as management information of the selected data item.

5. A computer data signal embodied in a carrier wave for enabling a computer connected to a storage that stores a plurality of data items and management information related to storing of each data item in an associated manner to perform a process comprising:
detecting, from the plurality of stored data items, a plurality of data items of which at least a part of contents are common to each other;
selecting a data item to be stored continuously from the detected data items; and
associating management information of a data item which is not selected from the detected data items with the selected data item as management information of the selected data item.

6. A method for a data storing device which stores a plurality of data items and management information related to storing of each data item in an associated manner, the method comprising:
detecting, from the plurality of stored data items, a plurality of data items of which at least a part of contents are common to each other;
selecting a data item to be stored continuously from the detected data items; and
associating management information of a data item which is not selected from the detected data items with the selected data item as management information of the selected data item.
